(19) United States
(12) Patent Application Publication
(10) Pub. No.: US 2022/0085526 A1
(43) Pub. Date: Mar. 17, 2022

(54) ANTI-CORROSION TERMINAL MATERIAL, TERMINAL, AND ELECTRICAL WIRE END SECTION STRUCTURE

(71) Applicant: MITSUBISHI MATERIALS CORPORATION, Tokyo (JP)

(72) Inventors: Kenji Kubota, Naka-shi (JP); Takashi Tamagawa, Naka-shi (JP); Toru Nishimura, Naka-shi (JP); Yoshie Tarutani, Naka-shi (JP); Kiyotaka Nakaya, Naka-shi (JP)

(73) Assignee: MITSUBISHI MATERIALS CORPORATION, Tokyo (JP)

(21) Appl. No.: 17/416,542

(22) PCT Filed: Dec. 27, 2019
(86) PCT No.: PCT/JP2019/051404

§ 371 Date: Jun. 21, 2021

(30) Foreign Application Priority Data
Dec. 27, 2018 (JP) 2018-244741

(51) Int. Cl. H01R 4/62; C25D 5/12; C25D 5/50; C25D 7/00

(52) U.S. Cl. CPC H01R 4/62; C25D 5/12; H01R 4/185; C25D 7/00; C25D 5/50

(57) ABSTRACT

Providing an anti-corrosion terminal material having high corrosion resistance effect and good adhesiveness of a film.

A first film is formed on at least a part of a base material in which at least a surface is made of copper or copper alloy; in the first film, a zinc layer made of zinc or zinc alloy is formed on a mixed layer in which a copper-tin alloy region made of copper tin alloy and a tin region made of tin or tin alloy other than copper tin alloy are mixed; the zinc layer is in contact with both the copper-tin alloy region and the tin region of the mixed layer; a ratio R1/R2 is 0.05 or more and 2.5 or less where a length in contact with the copper-tin alloy region in a cross section along a thickness direction is R1 (μm) and a length in contact with the tin layer is R2 (μm).

Priority is claimed on Japanese Patent Application No. 2018-244741, filed Dec. 27, 2018, the content of which is incorporated herein by reference.

### BACKGROUND OF THE INVENTION

### Technical Field

The present invention relates to an anti-corrosion terminal material, a terminal, and an electrical wire end section structure having high anti-corrosion effect.

### Background Art

Conventionally, by connecting a terminal crimped to a terminal end of a conductive wire to a terminal provided in another apparatus, the conductive wire is connected to the other apparatus. The conductive wire and the terminal are generally formed of highly conductive copper or copper alloy, however, conductive wires formed of aluminum or aluminum alloy are also used for weight reduction and the like.

For example, Patent Document 1 discloses an electric wire with a terminal on which a terminal made of copper (copper alloy) on which tin plating is formed is crimped to a conductive wire made of aluminum or aluminum alloy, and which is mounted on a vehicle such as an automobile.

When the conductive wire is formed of aluminum or aluminum alloy and the terminal is formed of copper or copper alloy, if water enters between the terminal and the conductive wire, there is a risk of galvanic corrosion due to a potential difference of different metals occurs and the conductive wire corrodes, so that electric resistance may be increased and a crimping force may be deteriorated at the crimp part.

In order to prevent the galvanic corrosion, for example, in Patent Document 1, an anti-corrosion layer made of metal (zinc or zinc alloy) having a sacrificial anti-corrosion effect on a base layer between the base layer and a tin layer of a terminal.

A electric contact material for a connector shown in Patent Document 2 has a base material made of metal material, an alloy layer formed on the base material, and a conductive film layer formed on a surface of the alloy layer. The alloy layer essentially contains Sn, and further contains one or more additive elements selected from Cu, Zn, Co, Ni, and Pd. As the conductive film layer, ones including Sn₃O₂(OH)₂ (hydroxy oxide) is disclosed.

As an example of adding Zn to Sn, an Sn plating material is disclosed in Patent Document 3. The Sn plating material has a base Ni plating layer, an intermediate Sn—Cu platin layer, and a surface Sn plating layer in this order on a surface of copper or copper alloy. In this Sn plating material, the base Ni plating layer is composed of Ni or Ni alloy; the intermediate Sn—Cu plating layer is composed of Sn—Cu based alloy in which an Sn—Cu—Zn alloy layer is formed at least on the side in contact with the surface Sn plating layer; and the surface Sn plating layer is composed of Sn alloy containing 5 to 1000 mass ppm of Zn and further has a Zn high concentration layer with a Zn concentration of more than 0.2 mass % and up to 10 mass %.

In Patent Document 4, in an Sn plating layer in which an Sn-containing layer is formed on a surface of a base material made of copper or copper alloy, the Sn-containing layer is composed of a Cu—Sn alloy layer and an Sn layer with at thickness not more than 5 μm formed on a surface of the Cu—Sn alloy layer, a Ni plating layer is formed on a surface of the Sn-containing layer, and a Zn plating layer is formed as an outermost layer on a surface of the Ni plating layer.

### Prior Art Document

### Patent Literature

Patent Document 1: Japanese Unexamined Patent Application, First Publication No. 2013-218866

Patent Document 2: Japanese Unexamined Patent Application, First Publication No. 2015-133306

Patent Document 3: Japanese Unexamined Patent Application, First Publication No. 2008-285729

Patent Document 4: Japanese Unexamined Patent Application, First Publication No. 2018-90875

### SUMMARY OF INVENTION

### Technical Problem

In a case in which an anti-corrosion layer made of zinc or zinc alloy is provided on the base of the tin layer as in Patent Document 1, tin substitution occurs when tin plating treatment is performed on the anti-corrosion layer, there was a problem that adhesiveness of the anti-corrosion layer and the tin plating may be deteriorated.

In a case in which a conductive film layer containing Sn₃O₂(OH)₂ (hydroxy oxide) is provided as in Patent Document 2, the conductive film layer is rapidly chipped when exposed in corrosion environment or heating environment, there is a problem that durability is low.

As in Patent Document 3, one in which an Sn—Zn alloy (the surface Sn plating layer) is laminated on an Sn—Cu based alloy layer (the intermediate Sn—Cu plating layer) and the Zn high-concentration layer is the outermost layer is poor in productivity of the Sn—Zn alloy plating and there is a problem that an anti-corrosion effect to the conductive wire made of aluminum is lost when copper in the Sn—Cu based alloy layer is exposed to the surface layer.

In the terminal using material in which the Zn plating layer is laminated on the Sn plating material in which the Cu—Sn alloy layer and the Sn layer are laminated as in Patent Document 4, since the adhesiveness of the Sn layer and Zn plating layer is extremely poor, the adhesiveness may be poor even if the Ni plating layer is intervened.

The present invention is achieved in consideration of the above-mentioned problem, and has an object to provide an anti-corrosion terminal material, a terminal, and an electric wire end section structure having high anti-corrosion effect and being excellent adhesiveness of a film.

### Solution to Problem

An anti-corrosion terminal material of the present invention is provided with a base material at least a surface is made of copper or copper alloy and a first film provided at at least a part of the base material; the first film has a mixed layer in which a copper-tin alloy region made of copper tin alloy and a tin region made of tin or tin alloy other than copper tin alloy, and a zinc layer made of zinc or zinc alloy provided on the mixed layer; the zinc layer is in contact with both the copper-tin alloy region and the tin region of the mixed layer, a ratio R1/R2 is 0.05 or more and 2.5 or less where a length in contact with the copper-tin alloy region in a cross section along a thickness direction is R1 (μm) and a length in contact with the tin layer is R2 (μm).

In this anti-corrosion terminal, since the copper-tin alloy region is mixed in the mixed layer, the zinc layer provided thereon is also in contact with the copper-tin alloy region having good adhesiveness to the zinc layer not only with the tin layer, so that the adhesiveness is improved. In this case, if the ratio R1/R2 is less than 0.05, the length in contact with the copper-tin alloy region is too small and the adhesiveness is deteriorated; and if the ratio R1/R2 exceeds 2.5, cracking occurs during bending and adhesiveness is rather impaired.

In a case in which the terminal material is formed into a terminal to connect an aluminum wire material of an electric wire, the first film is disposed at a portion where a core wire of the electric wire is in contact when it is formed into the terminal; so that it is possible to suppress the occurrence of dissimilar metal contact corrosion when it is in contact with the aluminum wire material since the corrosion potential is near to aluminum by the zinc layer.

One aspect of the anti-corrosion terminal material further includes an adhesive layer made of nickel or nickel alloy between the mixed layer and the zinc layer in the first film. The adhesive layer has good adhesiveness to the mixed layer (the tin region and the copper-tin alloy region) and the zinc layer, so it is possible to prevent peelings between the zinc layer and the mixed layer and improve the adhesiveness.

As another aspect of the anti-corrosion terminal material further includes intermetallic compound made of NiSn₄ entering into the tin region from the adhesive layer.

Since the intermetallic compound made of NiSn₄ enters into the tin region from the adhesive layer, the adhesiveness between the adhesive layer and the mixed layer becomes better. Accordingly, even in the case of severe processing to the terminal, delamination is prevented and the adhesion can be enhanced.

In another aspect of the anti-corrosion terminal material, the copper-tin alloy region contains not less than 1 at % and not more than 50 at % of nickel. When copper tin alloy contains nickel, the adhesion between the copper-tin alloy region and the zinc layer is better. If the content is less than 1 at %, the effect of improving the adhesion is poor; and if exceeds 50 at %, the copper tin alloy becomes fragile and the friction reducing effect is reduced. Since the copper-tin alloy region contains nickel in this range, the interface between the copper tin alloy region and the tin region can be formed into a steep uneven shape, and the hard copper-tin alloy and the soft tin are exposed on the surface, so that it is also advantageous to reduce the friction coefficient.

In yet another aspect of the anti-corrosion terminal material, an adhesion amount of zinc per unit area of the zinc layer is not less than 0.07 mg/cm² and not more than 2.0 mg/cm². Here, the “adhesion amount per unit area” means an amount included in a thickness x unit area of the zinc layer.

If the zinc adhesion amount of the zinc layer is less than 0.07 mg/cm², an amount of zinc is not sufficient and the corrosion current value tends to be high; if it exceeds 2.0 mg/cm², the amount of zinc is too much and the contact resistance tends to be high.

In yet another aspect of the anti-corrosion terminal material, the first film further has a tin layer made of tin or tin alloy provided on the zinc layer.

Since the tin layer prevents the zinc layer from corroding, the corrosion resistance can be more improved. Since zinc in the zinc layer is diffused to the tin layer through crystal boundaries, the corrosion potential of the tin layer is near to aluminum, so that the occurrence of the dissimilar metal contact corrosion can be effectively suppressed when in contact with the aluminum wire material. Moreover, even when the entire or a part of the tin layer is lost by abrasion or the like, the dissimilar metal contact corrosion can be suppressed by the zinc layer thereunder; it is possible to prevent the electric resistance value from increasing and the crimping force to the aluminum wire material from decreasing.

In yet another aspect of the anti-corrosion terminal material, the zinc layer contains one or more of nickel, iron, manganese, molybdenum, cobalt, cadmium, and lead as an added element, and an adhesion amount of the added element per unit area is not less than 0.01 mg/cm² and not more than 0.3 mg/cm².

The zinc layer contains the added elements to be zinc alloy, the corrosion resistance of the zinc layer itself can be more improved. Zinc alloy containing nickel as the added element is particularly desirable since having high effect of improving the corrosion resistance of the zinc layer.

In a case in which the tin layer is formed on the zinc layer, the zinc layer is zinc alloy to prevent excessive diffusion of zinc to the tin layer can be prevented. When the tin layer is exposed to the corrosive environment and disappears, it is possible to maintain the zinc layer long and to prevent the increase of the corrosion current. If the adhesion amount of the added element is less than 0.01 mg/cm², the effect of suppressing diffusion of zinc to the tin layer is poor; and if it exceeds 0.3 mg/cm², zinc is insufficient in the tin layer and the corrosion current may be increased. Since the adhesion amount of the added element is within this range, a suitable amount of zinc is diffused to the tin layer from the zinc layer.

In yet another aspect of the anti-corrosion terminal material, a second film provided on a part of the base material in which the first film is not formed is provided, the second film has a mixed layer provided on the base material, the copper-tin alloy region and the tin region are exposed on the surface of the mixed layer, and an exposed area rate of the copper-tin alloy region is not less than 5% and not more than 70%.

Although the hard copper-tin alloy region is exposed on the surface of the second film, lubricant action by the soft tin region therearound, the friction coefficient can be reduced. In this case, the effect of reducing the friction coefficient is small if the exposed are ratio of the copper-tin alloy region is less than 5%; if it exceeds 70%, the exposed area of the tin region is small and the electrical connection characteristics may be deteriorated.

The anti-corrosion terminal material of the present invention has a strip-shaped carrier part and a plurality of terminal members connected to the carrier part at an interval in a longitudinal direction of the carrier part.

A terminal of the present terminal is a terminal formed by the above-described anti-corrosion terminal material. In an electrical wire end section structure of the present invention, the anti-corrosion terminal is crimped on an end of an electric wire made of an aluminum wire material made of aluminum or aluminum alloy.

### Advantageous Effects of Invention

According to the present invention, since the zinc layer is in contact with both the tin region and the copper-tin alloy region of the mixed layer, the adhesiveness is good, and it is possible to prevent the occurrence of dissimilar metal contact corrosion in a case in which it is contact as a terminal with the aluminum wire material.

### BRIEF DESCRIPTION OF DRAWINGS

FIG. 1 It is an essential cross-sectional view schematically showing an embodiment of an anti-corrosion terminal material of the present invention.

FIG. 2 It is a plan view of the anti-corrosion terminal material of the present embodiment.

FIG. 3 It is a perspective view showing an example of a terminal on which the anti-corrosion terminal material of the present embodiment is applied.

FIG. 4 It is a front view showing an end section of an electric wire on which the terminal in FIG. 3 is crimped.

FIG. 5 It is an SIM (scanning ion microscope) image of Example 11.

FIG. 6 It is an enlarged TEM (transmission electron microscope) image of a part surrounded by the circle in FIG. 5.

### DESCRIPTION OF EMBODIMENTS

An anti-corrosion terminal material 1, a terminal 10, and an electric wire end section structure by the terminal 10 of one embodiment of the present invention will be explained.

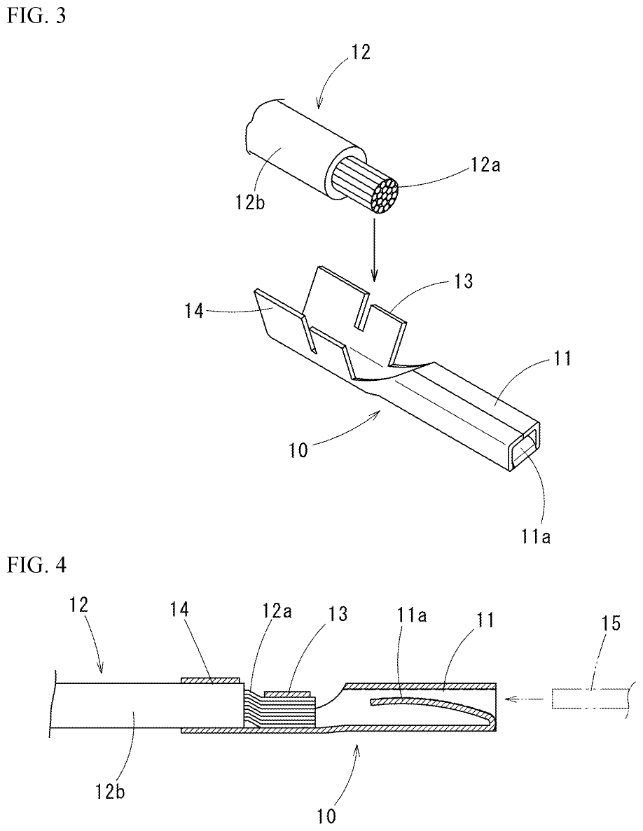

The anti-corrosion terminal material 1 of the present embodiment is a strip material formed in a belt shape to form a plurality of the terminals 10 (refer to FIG. 3); between a pair of belt-shaped carrier parts 21 extending in parallel a plurality of terminal members 22 formed to be the terminals 10 are disposed with intervals in a longitudinal direction; and both ends of the terminal members 22 are connected to both carrier parts 21 via narrow connection sections 23. The terminal members 22 are formed in the shape shown in FIG. 3 for example, and cut off from the connection sections 23 to be finished as the terminals 10 (refer to FIG. 4).

In the terminal 10 (a female terminal in the example of FIG. 3), a connection part 11 to which a male terminal 15 (refer to FIG. 4) is fit inserted, a core wire crimping part 13 to which an exposed core wire (aluminum wire material) 12a of an electric wire 12 is crimped, and a covering crimping part 14 a covering part 12b of the electric wire 12 is crimped are arranged in this order and integrally formed. The electric wire is formed in a square tube; a spring piece 11 a continued to a tip end thereof is folded and inserted inside.

FIG. 4 shows an end section structure in which the terminal 10 is crimped on the electric wire 12. In this electric wire end section structure, the core wire 12a of the electric wire 12 is directly in contact with the vicinity of the core wire crimping part 13.

In the strip-shaped anti-corrosion terminal material 1 shown in FIG. 2, a part forming the connection part 11 when the terminal 10 is formed to be in contact with the male terminal 15 and becomes a contact point is defined as a contact planned part 25; and a surface of a part in contact with the core wire 12a in the vicinity of the core wire crimping part 13 is defined as a core wire contact planned part 26.

When the terminal 10 (a female terminal) of the present embodiment is formed, the contact planned part 25 becomes an inner surface of the connection part 11 formed into the square tube shape and a surface opposite to the spring piece 11a folded inside the connection part 11. As shown in FIG. 2, in a state in which the connection part 11 is unfolded, surfaces at both sides of the connection part 11 and a back surface of the spring piece 11a are the contact planned parts 25.

The contact planned part 25 which is in contact with the male terminal 15 is required to have small electric resistance and small friction resistance. The core wire contact planned part 26 which is in contact with the core wire (aluminum wire material) 12a is required to have small electric resistance and corrosion potential near to that of the core wire 12a so that the corrosion of dissimilar metal contact can be suppressed.

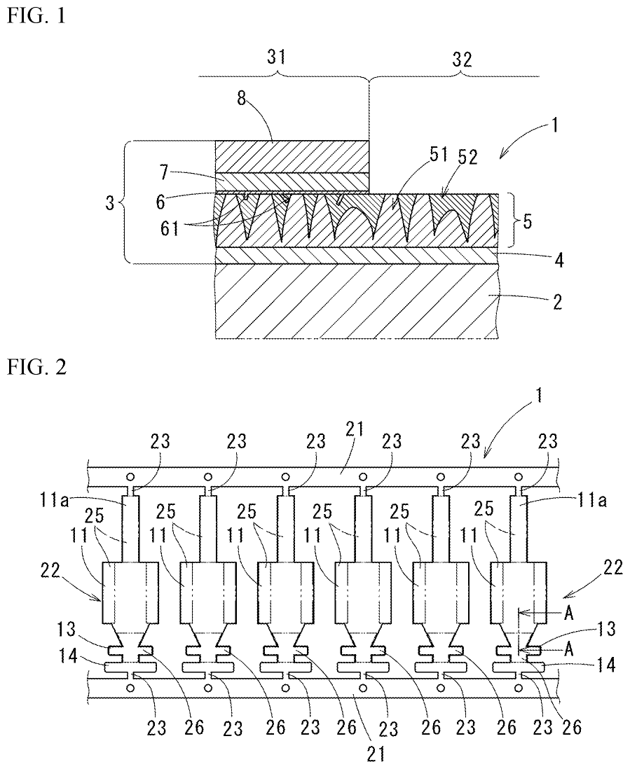

In the anti-corrosion terminal material 1, as a cross section (corresponding a cross section along the line A-A in FIG. 2) schematically shown in FIG. 1, a film 3 is formed on a base material made of copper or copper alloy.

In the film 3, a base layer 4 made of nickel or nickel alloy and a mixed layer 5 in which a copper-tin alloy region made of copper tin alloy and tin region made of tin or tin alloy other than copper tin alloy are mixed are formed in this order on the base material 2; on a surface of the core wire contact planned part 26, an adhesive layer 6 made of nickel or nickel alloy and a zinc layer 7 made of zinc or zinc alloy are further formed on the mixed layer 5 in this order; and furthermore in the present embodiment, a tin layer 8 made of tin or tin alloy is formed on the zinc layer 7. Of the film 3, a film formed on the surface of the core wire contact planned part 26 is defined as a first film 31 and a film formed on a surface other than the core wire contact planned part 26 (including the contact planned part 25) is defined as a second film 32.

In other words, here, the first film 31 formed on the surface of the core wire contact planned part 26 and the second film 32 formed on the surface of other part except the core wire contact planned part 26 are generally called as the “film 3”. The second film 32 is provided with the base layer 4 made of nickel or nickel alloy formed on the base material 2 and the mixed layer 5 made of copper tin alloy and tin other than copper tin alloy or tin made of tin alloy are mixed and formed on the base layer 4. The first film 31 is provided with, in addition to the film 32, the adhesive layer 6 made of nickel or nickel alloy and formed on the mixed layer 5, the zinc layer 7 made of zinc or zinc alloy and formed on the adhesive layer 6, and the tin layer 8 made of tin or tin alloy and formed on the zinc layer 7.

That is to say, in the first film 31, the base layer 4, the mixed layer 5, the adhesive layer 6, the zinc layer 7, and the tin layer 8 are formed in this order on the base material 2 as above-described. The second film 32 is formed of the base layer 4 and the mixed layer 5 in this order on the base material 2. The first film 31 is preferably exist at not less than 30% and not more than 80% of an area rate to a surface (a surface of the terminal members 22) after formed as the terminal 10. These details are described below.

Composition and the like of the base material 2 is not specifically limited if at least the surface of the base material 2 is made of copper or copper alloy. It is good to use a plate material made of copper or copper alloy; and a plate material made of metal (e.g., stainless steel) other than copper in which copper layer such as a copper-plating layer or the like made of copper or copper alloy is applied to the surface thereof may be used. The base material 2 may be a flat plate or a strip (FIG. 2) obtained by processing a flat plate.

The base layer 4 is made of nickel or nickel alloy; for example, with a thickness of not less than 0.1 μm and not more than 5.0 μm, and a nickel content by percentage is not less than 80 mass %. The base layer 4 has a function of preventing diffusion of copper from the base material 2 to the zinc layer 7 and the tin layer 8, so that it is desirable to be formed. It is preferable that a nickel content by percentage of the base layer 4 be not less than 90 mass %.

The mixed layer 5 is a layer obtained by sequentially forming a copper-plating layer and a tin-plating layer on the base layer 4 and reflowing them; a copper-tin alloy region 51 made of copper tin alloy such as Cu₆Sn₅ or Cu₃Sn and a tin region 52 made of tin or tin alloy other than the copper-tin alloy are mixed, and both of the copper-tin alloy region 51 and the tin region 52 are exposed on the surface. When the base layer 4 is not provided, the mixed layer 5 is provided directly on the base material 2.

An average thickness of the mixed layer 5 is preferably 0.1 μm or more and 3.0 μm or less. In this case, internal strain in the tin-plating layer is released by the reflow treatment; so that the mixed layer is formed uniformly, and tin whiskers are hardly generated. If the reflow treatment is insufficient and the average thickness of the mixed layer 5 becomes too thin, the internal strain the tin-plating layer cannot be completely released, and the tin whiskers are easily generated. On the other hand, if the average thickness of the mixed layer 5 is too thick, cracks are likely to occur during processing.

The copper-tin alloy region 51 structuring the mixed layer 5 contains not less than 1 at % and not more than 50 at % of nickel. When the copper tin alloy contains nickel, the adhesion to the zinc layer 7 becomes better. If the nickel content is less than 1 at %, the effect of improving the adhesion is poor; and if it exceeds 50 at %, the copper tin alloy becomes brittle and the effect of reducing friction is reduced. If the nickel content is not less than 1 at % and not more than 50 at %, the interface between the copper-tin alloy region 51 and the tin region 52 can be formed into a steep uneven shape: that is, the surface of the hard copper-tin alloy region 51 having the steep uneven shape is made even by the soft tin region 52, so that it is effective to reduce the friction coefficient.

The adhesive layer 6 provided on the mixed layer 5 is made of nickel or nickel alloy. The adhesive layer 6 is not essential; however, the adhesive layer 6 can improve the adhesion between the mixed layer 5 and the zinc layer 7, particularly, it is excellent in the effect of preventing the peeling in the corrosive environment. The adhesive layer 6 functions as a barrier for preventing copper component diffusion at high temperature from the base material 2, and contributes to improvement of heat resistance (prevention of deterioration of corrosion resistance due to high temperature).

Since the tin region 52 in the mixed layer 5 is easily oxidized, an oxide film obstructing electrodeposition and not easily removed is easily generated. In order to electrodeposit nickel on the tin region 52, it is desirable to form a nickel-plating layer with good adhesion to tin by electrolytic plating using a nickel strike plating bath which activates a surface of the tin region 52.

The adhesive layer 6 has an average thickness of not less than 0.01 μm and not more than 1.0 μm. If the thickness of the adhesive layer 6 is less than 0.01 μm, the effect of improving adhesion of the zinc layer 7 is poor. Although it does not matter if the adhesive layer 6 is thick, 1.0 μm is sufficient since it has a sufficient effect of improving adhesion. The preferable thickness of the adhesive layer 6 is not less than 0.05 μm and not more than 0.3 μm.

In the tin region 52 of the mixed layer 5, intermetallic compound 61 made of NiSn₄ is formed in a state of entering from the adhesive layer 6 (refer to FIG. 6). The intermetallic compound 61 is formed into scaly, acicular, or columnar shape, and extends into the tin region 52 with penetrating the interface of the mixed layer 5 from the adhesive layer 6. Since the intermetallic compound 61 is formed by connecting the adhesive layer 6 and the mixed layer 5, the adhesion between the tin region 52 and the adhesive layer 6 becomes better, and peeling can be reliably prevented in a corrosive environment.

Since the adhesive layer 6 is provided between the zinc layer 7 and the mixed layer 5 but is extremely thin, it may be considered that the zinc layer 7 and the mixed layer 5 are substantially in direct contact with each other.

The zinc layer 7 is made of zinc or zinc alloy, has a thickness of 0.1 μm or more and 5.0 μm or less, and a zinc adhesion amount per unit area of 0.07 mg/cm² or more and 2.0 mg/cm² or less. If the zinc adhesion amount is less than 0.07 mg/cm², the amount of zinc is insufficient and the corrosion current value tends to be high; and if it exceeds 2.0 mg/cm², the amount of zinc is too much and the contact resistance tends to be high. Here, the zinc adhesion amount per unit area refers to the amount of zinc included in the thickness of the zinc layer 7×unit area.

If the thickness of the zinc layer 7 is less than 0.1 μm, the effect of reducing the corrosion current of the surface (the tin layer 8) of the first film 31 is poor; and if it exceeds 5.0 μm, press workability is deteriorated, so that cracking may occur at the time of press working into the terminal 10. The thickness of the zinc layer 7 is more preferably 0.3 μm or more and 2.0 μm or less.

Since the zinc layer 7 is formed on the mixed layer 5, it contacts both the copper-tin alloy region 51 and the tin region 52 of the mixed layer 5. In any cross section in the thickness direction, when a total of lengths of portions in which the zinc layer 7 and the copper-tin alloy region 51 are in contact with each other is R1 (μm) and a total of lengths of portions in which the zinc layer 7 and the tin region 52 are in contact with each other is R2 (μm), a ratio R1/R2 is 0.05 or more and 2.5 or less. If the ratio R1/R2 is less than 0.05, the length (area) in contact with the copper-tin alloy region 51 is too small and the adhesion is deteriorated; and if the ratio R1/R2 exceeds 2.5, the hard copper-tin alloy region 51 is too large, so that cracks are generated in the bending process, and the adhesion rather deteriorated.

The zinc layer 7 may contain, in addition to zinc, any one or more of nickel, iron, manganese, molybdenum, cobalt, cadmium, lead, and tin as an additive element. The corrosion resistance of the zinc layer 7 can be improved by adding these additive elements to the zinc layer 7 to form zinc alloy. Nickel zinc alloy is particularly preferable since it has high effect of improving the corrosion resistance of the zinc layer 7. In a case in which the tin layer 8 is formed on the zinc layer 7, excessive zinc diffusion to the tin layer 8 can be prevented. Moreover, when the tin layer 8 is exposed in the corrosive environment and disappears, the zinc layer 7 is maintained for a long while and it is possible to prevent the increase of the corrosion current.

When the zinc layer 7 contains the additive element(s), it is good that the adhesion amount of the additive element(s) is 0.01 mg/cm² or more and 0.3 mg/cm² or less. If the adhesion amount of the additive element(s) is less than 0.01 mg/cm², the effect of reducing the diffusion of zinc to the tin layer 8 is poor; and if it exceeds 0.3 mg/cm², the diffusion of zinc to the tin layer 8 is insufficient and the corrosion current may be increased. Here, the adhesion amount of the additive element refers to a product of the thickness of the zinc layer and the amount of the additive element contained in unit area.

The tin layer 8 is made of tin or tin alloy, covers the surface of the zinc layer 7 and prevent the corrosion of the zinc layer 7 to improve the anti-corrosion characteristic. By diffusing zinc from zinc layer 7 to the tin layer 8, the corrosion potential of the tin layer 8 approaches that of aluminum, so it is possible to effectively reduce the corrosion of dissimilar metal contact when it contacts with the aluminum wire material. Moreover, even when all of or a part of the tin layer 8 disappears due to abrasion and the like, the dissimilar metal contact corrosion can be suppressed by the zinc layer 7 thereunder, and the increase of the electric resistance value and the lowering of the crimping force to the aluminum wire material can be suppressed.

The thickness of the tin layer 8 is preferably 0.3 ∞m or more and 8.0 μm or less. If the thickness of the tin layer 8 is less than 0.3 μm, the effect of improving the anti-corrosion characteristic is poor; and if the thickness of the tin layer 8 exceeds 8.0 μm, since it is too thick, zinc is not easily diffused from the zinc layer 7 to the surface of the tin layer 8.

Since zinc diffuses from the zinc layer 7, the adhesion amount of zinc per unit area in the zinc layer 7 and the tin layer 8 as a whole ((zinc amount contained in the zinc layer 7+zinc amount contained in the tin layer 8)÷an area of the zinc layer 7 (i.e., an area of the tin layer 8)) is 0.07 mg/cm² or more and 2.0 mg/cm² or less.

The second film 32 is formed from the base layer 4 and the mixed layer 5 having the same composition and thickness as those in the base layer 4 and the mixed layer 5 in the first film 31. Both of the copper-tin alloy region 51 and the tin region 52 of the mixed layer 5 are exposed on the outermost surface of the film 32. An exposed area ratio of the copper-tin alloy region 51 is 5% or more and 70% or less.

The second film 32 is the contact planned part 25 and can reduce the friction coefficient by the lubricating action due to the hard copper-tin alloy region 51 dappled and exposed on the surface and the soft tin region 52 exposed around the copper-tin alloy region 51. In this case, if the exposed area ratio of the copper-tin alloy region 51 is less than 5%, the effect of reducing the friction coefficient is small; and if it exceeds 70%, the electric connection characteristics may decrease.

In the film 3 having the above-described layer structure, the first film 31 is present on the surface of portions excluding the contact planned part 25 as described above. Since the corrosion current due to the dissimilar metal contact also flows portions separated from the contact portion and generate corrosion, it is desirable that the ratio of portions in which the zinc layer 8 is present to prevent galvanic corrosion is higher. It is desirable that the zinc layer 8 is present at 30% or more and 80% or less of an area ratio in the whole surface when it is formed as the terminal 10.

Next, a method of manufacturing the anti-corrosion terminal material 1 will be explained.

As the base material 2, a plate material made of copper or copper alloy is prepared. As described above, a plate material in which a copper layer made of copper or copper alloy is formed on a metal plate (such as stainless steel) other than copper may be used. By performing processes such as cutting, drilling and the like on the plate material (the base material 2), a strip shape in which a plurality of the terminal members 22 are connected to the carrier part 21 via the connection sections 23 is formed.

<Step of Forming Nickel-Plating Layer for Base>

A nickel-plating layer to be the base layer 4 is formed on the base material 2 by performing a treatment forming a nickel-plating layer made of nickel or nickel alloy on a whole surface after cleansing the surface of the strip-shape base material 2 by performing degreasing, pickling and the like.

The nickel-plating treatment is not particularly limited as long as a dense nickel-based film is obtained, and the nickel-plating layer can be formed by electroplating using a known watt-bath, sulfamic acid bath, citric acid bath or the like. In view of press bendability to the terminal 10 and barrier characteristics to copper, pure nickel-plating treatment obtained from the sulfamic acid bath is desirable.

<Step of Forming Mixed Layer>

After the nickel-plating layer is formed, by sequentially performing the copper plating treatment and the tin plating treatment, a copper-plating layer made of copper or copper alloy and a tin-plating layer made of tin or tin alloy are formed on the nickel-plating layer. Thereafter, by heating treatment (reflow treatment), the mixed layer 5 is formed on the base layer 4 made of nickel or nickel alloy.

For the copper plating treatment in this case, a general copper plating bath can be used: for example, such as copper sulfate bath in which copper sulfate (CuSO₄) and sulfuric acid (H₂SO₄) as main ingredients.

For the tin plating, general tin plating bath can be used: for example, a sulfuric bath in which sulfuric acid (H₂SO₄) and stannous sulfate (SnSO₄) as main ingredients.

As the reflow treatment, surface temperature of the base material 2 is raised to 240° C. or more and 360° C. or less, maintained at this temperature for one second or more and 12 seconds or less, and then rapidly cooled.

By applying this reflow treatment, the mixed layer 5 in which copper tin alloy and tin are mixed is formed on the base layer 4. In this case, by controlling a thickness of the copper-plating layer to an optimum value, the tin-plating layer, the copper-plating layer and the nickel-plating layer are mutually diffused and the copper tin alloy containing nickel can grow. The exposure rate of the copper-tin alloy region 51 on the surface of the mixed layer 5 can be varied by adjusting the heat treatment conditions of reflow and the thickness of the respective layers.

It is acceptable to form the tin-plating layer on the nickel-plating layer without forming the copper-plating layer and performing the heat treatment. In this case, for the sake of forming the copper-tin alloy region 51, the nickel-plating layer is thinly formed and copper is supplied from the base material 2 during the heat treatment.

<Step of Forming Nickel-Plating Layer for Adhesion>

In the case of forming the adhesive layer 6, the contact planned part 25 on the surface of the base material 2 on which the mixed layer 5 is formed is masked, and then the nickel-plating layer is formed in that state.

The nickel-plating layer is made of nickel or nickel alloy and can be formed by electroplating or electroless plating. It is preferable for plating to use a known nickel strike bath made of nickel chloride and hydrochloric acid; although the nickel-plating layer can be also formed from another bath such as a citric acid bath and a sulfamic acid bath. In the case of forming the adhesive layer 6 from nickel alloy, it is possible to form the film from a nickel-tin alloy plating bath commercially available or a nickel-phosphorus alloy plating bath made of phosphorus acid and nickel sulfate.

The nickel-plating layer can be formed having good adhesiveness to the mixed layer 5 in which copper tin alloy and tin are mixed, if a pre-treatment for forming the nickel-plating layer is carried out by immersing the base material 2 (strip shape) on which the mixed layer 5 is formed in alkaline aqueous solution with pH=10 or more. The adhesion of the nickel-plating layer is better if the alkaline aqueous solution contains a complexing agent capable of complexing both tin and copper.

In this case, the intermetallic compound 61 made of NiSn₄ can be formed by mutually diffusing nickel in the nickel-plating layer and tin in the mixed layer 5. However, if the pre-treatment used for copper alloy such as pickling with sulfuric acid is used, an oxide film of tin may remain and the growth of NiSn₄ may be inhibited. In order to prevent this and to grow NiSn₄, it is desirable that the oxide film of tin is removed by immersing the sufficiently degreased base material 2 having the mixed layer 5 in sodium hydroxide of 30 g/L for five seconds or more, and then immediately the nickel strike plating is performed.

After forming the nickel-plating layer for adhesion, all of the plating films are formed including a zinc-plating layer and a tin-plating layer stated below and then the heat treatment is carried out, so that the adhesive layer 6 is formed, and the intermetallic compound 61 made of NiSn4 grows from the adhesive layer 6 in the tin region 52 of the mixed layer 5.

<Step of Forming Zinc-Plating Layer>

The zinc-plating layer for forming the zinc layer 7 can be formed by electrodeposition of an electroplating zinc plating bath using a known sulfate bath or a zincate bath. In a case of not forming the adhesive layer 6 under the zinc layer 7, a film having relatively good adhesion can be obtained by using the sulfate bath with strong acidity.

Zinc alloy plating treatment can be carried out utilizing a nickel zinc alloy plating using a sulfate bath, a chloride bath, or an alkaline bath, a zinc cobalt alloy plating treatment using a sulfate bath, a zinc manganese alloy plating treatment using a citric acid-containing sulfate bath, and a zinc molybdenum plating treatment using a sulfate bath. It is also possible to use a vapor deposition method instead of the plating method. In a case of laminating the terminal 8 on the zinc layer 7, the zinc layer 7 can be prevented from being damaged by the substitution reaction if the zinc-plating layer is zinc alloy.

<Step of Forming Tin-Plating Layer>

Electroplating treatment can be applied to form the tin-plating layer for forming the tin layer 8: for example, an organic acid bath (e.g., a phenol sulfonic acid bath, an alkane sulfonic acid bath or an alkanol sulfonic acid bath), an acidic bath (such as a fluoroboric acid bath, a halogen bath, a sulfuric acid bath, a pyrophosphate bath, or the like), or an alkaline bath (such as a potassium bath, a sodium bath, or the like) or the like is used. In view of the high-speed film productivity, the density of the films and the ease of diffusion of zinc, it is beneficial to use an acidic organic acid bath or sulfuric acid bath and to add nonionic surfactant to the bath as an additive.

In order to advance the mutual diffusion between the zinc-plating layer and the tin-plating layer at normal temperature (25° C.), it is important for the zinc-plating layer having a clean surface before laminating the tin-plating layer. In a case of forming the zinc-plating layer and the tin-plating layer sequentially by plating, it is preferable to form the tin-plating layer immediately after cleansing with an aqueous sodium hydroxide solution or an aqueous ammonium chloride solution in order to remove the hydroxide or oxide quickly formed on the surface of the zinc-plating layer. When the tin-plating layer is formed with a dry method such as deposition or the like, it is preferable to etch the surface of the zinc-plating layer by an argon spattering treatment and then form the tin-plating layer.

<Step of Heat Treatment>

Heat treatment is applied to a material in which the mixed layer 5, the zinc-plating layer and the tin-plating layer are sequentially formed on the base material 2. The heat treatment is carried out at temperature at which a surface temperature of the material becomes 30° C. or higher and 190° C. or lower. By this heat treatment, in portions (unmasked portions) other than the contact planned part 25, zinc in the zinc-plating layer diffuses into the tin-plating layer and on the tin-plating layer.

Since the diffusion of zinc occurs quickly, it is preferable to expose to temperature 30° C. or higher for 36 hours or less. However, melted tin is repelled by zinc alloy and tin-repelled portions are formed on the tin layer 5: i.e., the tin layer 5 is partly not formed and the zinc layer 7 is exposed; accordingly, it is not heated to temperature higher than 190° C. not to melt tin.

If exposed to over 160° C. for a long period of time, tin diffused to the zinc layer 4 conversely, and the diffusion of zinc to the tin layer 5 may be obstructed. Therefore, as a more preferable condition, heating temperature is 30° C. or higher and 160° C. or lower, and heat retention time is 30 minutes or more and 60 minutes or less. By this heat treatment, the adhesive layer 6, the zinc layer 7, and the tin layer 8 are formed on the mixed layer 5.

The anti-corrosion terminal material 1 produced as above is a strip material in which the base layer 3 made of nickel or nickel alloy and the mixed layer 5 formed from the copper-tin alloy region 51 and the tin region 52 thereon are formed on the base material 2 as a whole; in the contact planned part 25 where covered by a mask, the copper-tin alloy region 51 and the tin region 52 of the mixed layer 5 exposes to the surface; and in the portions other than the contact planned part 25, the adhesive layer 6, the zinc layer 7, and the tin layer 8 are formed on the mixed layer 5 in order.

Then, the strip material is processed as it is into the shape of the terminal shown in FIG. 3 by press processing or the like before cutting the connection sections 23. Then, cutting the connection sections 23, the terminals 10 are formed.

FIG. 4 shows an end section structure in which the terminal 10 is crimped to the electric wire 12: the vicinity of the core wire crimping part 13 is brought into direct contact with the core wire 12a of the electric wire 12.

In the core wire contact planned part 26 of the terminal 10, since the corrosion potential of zinc contained in the tin layer 8 is nearer to that of aluminum comparing to the corrosion potential of tin, the corrosion potential of the tin layer 8 in the core wire contact planned part 26 is near to aluminum. Accordingly, the respect of preventing the corrosion of the core wire 12a (aluminum wire material) made of aluminum is high, and the corrosion of dissimilar metal contact can be effectively prevented even in a state in which the core wire contact planned part 26 is crimped to the core wire 12a.

In this case, since the plating treatment and the heat treatment are carried out on the strip material in FIG. 2, the base material 2 is not exposed excepting the small portions (a cross section cut from the connection sections 23) connected by the connection sections 23 also in the end surface of the terminal 10, so that excellent anti-corrosion effect can be shown.

Moreover, since the zinc layer 7 is formed under the tin layer 8, even when the entire or a part of the tin layer 8 is lost by abrasion and the like, the corrosion of dissimilar metal contact can be reliably suppressed since the zinc layer 7 thereunder has corrosion potential near to aluminum.

In the first film 31 having high corrosion resistance, the zinc layer 7 provided on the mixed layer 5 is in contact with not only the tin region 52 of the mixed layer 5 but also with the copper-tin alloy region 51 with high adhesion to the zinc layer 7 and the adhesion is improved, so the peeling can be prevented. Moreover, since the adhesive layer 6 intervenes between the mixed layer 5 and the zinc layer 7, the adhesion of the mixed layer 5 and the zinc layer 7 can be further improved. Furthermore, since the intermetallic compound 61 made of NiSn₄ is formed to enter the tin region 52, the adhesion of the adhesive layer 6 and the mixed layer 5 is also improved.

In the second film 32 of the contact planned part 25, the mixed layer 5 made of the copper-tin alloy region 51 and the tin region 52 is disposed on the surface. Since the hard copper-tin alloy region 51 is exposed and the soft tin region 52 is provided around it, the friction coefficient can be reduced by the lubricating action of tin. Moreover, the tin region 52 is subjected to reflow treatment so that the contact resistance is also small, showing excellent electric characteristics as a contact of a connector.

In the above-described method, the strip material is formed from a plate material to have a shape in which a plurality of the terminal members are connected to the carrier parts and then the surface treatments are carried out, though the strip material may be formed after carrying out the surface treatments on the plate material. In this case, the base material 2 is punched out in the state in which the layers are provided on the surface and the carrier parts and the connector members are formed, so the base material 2 is exposed at the section by punching.

In addition, a thin metal zinc layer (a surface metal zinc layer) may be formed on the tin layer 8; in this case, generation the corrosion due to contact with the core wire 12a made of aluminum can be reliably suppressed. The surface metal zinc layer is a layer formed on the surface of the tin layer 8 by the above-described heat treatment diffusing zinc in the zinc alloy plating layer to the surface via the tin-plating layer, and is different from the zinc layer 7 provided under the tin layer 8.

### EXAMPLES

Examples 1 to 4 use a copper plate of C1020 as a base material; the copper plate was punched into the shape shown in FIG. 2 to form the strip material, subjected to degreasing and pickling; tin-plating was applied thereon and the reflow treatment was carried out; then, masking the contact planned part and applying zinc-plating, the first film and the second film were produced.

In Example 5, the adhesive layer was formed by nickel strike plating on samples of Examples 1 to 4 before the zinc-plating treatment, the heat treatment at 130° C. for 0.5 hour was carried out after the zinc-plating treatment.

Examples 6 to 9 were formed by applying nickel-plating, copper-plating and tin-plating in order on the strip-shaped base material degreased and pickled, carrying out the reflow treatment, and then applying nickel-strike plating and zinc-plating except for the contact planned part. The nickel-strike plating of Example 6 was tin nickel alloy plating. Furthermore, after the zinc plating treatment, the heat treatment of 150° C. for 0.5 hour on Example 6 and the heat treatment of 30° C. for 24 hours on Examples 7 to 9 were carried out.

In Examples 10 to 17 were formed by applying nickel-plating, copper-plating and tin-plating in order on the strip-shaped base material degreased and pickled, carrying out the reflow treatment, then applying nickel-strike plating, zinc-plating and tin-plating in order except for the contact planned part, and carrying out the heat treatment of 30° C. for 24 hours. The nickel-strike plating of Example 11 was nickel phosphorus alloy plating. For the zinc plating of Examples 11 to 17, the elements shown in Table 1 were added.

Comparative Examples were produced: one in which copper-plating and tin-plating were applied in order on the strip-shaped base material degreased and pickled, the reflow treatment was carried out, and the copper-tin alloy region was not exposed at the surface (Comparative Example 18); and one in which the reflow treatment was carried out for a long time so that almost the entire surface was covered with the copper-tin alloy region and a little tin region was present (Comparative Example 19). In Comparative Examples 18 and 19, portions corresponding the first film which was formed in Examples 1 to 17 was not formed.

Main plating conditions are described below.

<Nickel Plating Condition>

COMPOSITION OF PLATING BATH
Nickel sulfamate: 300 g/L
Nickel chloride: 5 g/L
Boric acid: 30 g/L

BATH TEMPERATURE: 45° C.

CURRENT DENSITY: 5 A/dm²

<Zinc Plating Condition>

(no addition element to the zinc layer)

COMPOSITION OF PLATING BATH
Zinc sulfate heptahydrate: 250 g/L
Sodium sulfate: 150 g/L

pH=1.2

BATH TEMPERATURE: 45° C.

CURRENT DENSITY: 5 A/dm²

<Zinc Plating Condition>

(Addition element to the zinc layer: nickel)

COMPOSITION OF PLATING BATH
Zinc sulfate heptahydrate: 75 g/L
Nickel sulfate hexahydrate: 180 g/L
Sodium sulfate: 140 g/L

pH=2.0

BATH TEMPERATURE: 45° C.

CURRENT DENSITY: 5 A/dm²

<Zinc Plating Condition>

(Addition element to the zinc layer: manganese)

COMPOSITION OF PLATING BATH
Manganese sulfate monohydrate: 110 g/L
Zinc sulfate heptahydrate: 50 g/L
Torisodium citrate: 250 g/L

pH=5.3

BATH TEMPERATURE: 30° C.

CURRENT DENSITY: 5 A/dm²

<Zinc Plating Condition>

(Addition element to the zinc layer: molybdenum)

COMPOSITION OF PLATING BATH
Ammonium heptamolybdate (IV): 1 g/L
Zinc sulfate heptahydrate: 25 g/L
Torisodium citrate: 250 g/L

pH=5.3

BATH TEMPERATURE: 30° C.

CURRENT DENSITY: 5 A/dm²

<Tin Plating Condition>

COMPOSITION OF PLATING BATH
Tin methane sulfonate: 200 g/L
Methane sulfonic acid: 100 g/L
Gloss agent

BATH TEMPERATURE: 25° C.

CURRENT DENSITY: 5 A/dm²

Regarding the obtained samples of Examples and Comparative Examples, measured were followings: a ratio (R1/R2) of a total R1 (μm) of length where the zinc layer is in contact with the copper-tin alloy region of the mixed layer and a total R2 (μm) of length where the zinc layer is in contact with the tin region in a cross section in a thickness direction; presence of the adhesive layer, and its composition and a thickness if the adhesive layer is present; presence of NiSn₄ entering the tin region of the mixed layer; the nickel content percentage in the copper-tin alloy region of the mixed layer; presence of the tin layer, and its thickness if the tin layer is present; the zinc adhesion amount in the zinc layer; an added element and the adhesion amount thereof; and an exposed rate of the copper-tin alloy region in the mixed layer at the contact planned part.

<R1/R2>

In the measurement of R1 and R2, samples cross-sectioned with a focused ion beam system: FIB (model number: SMI3050TB) manufactured by Seiko Instruments Inc. were observed with a scanning ion microscope, and the length in contact with each layer was measured from a cross section with a field of wide of 15 μm square. Two views were observed and the average value was taken. In addition, in a case in which the adhesive layer is present between the zinc layer and the mixed layer, the adhesive layer was regarded as a part of the zinc layer, and R1 and R2 were measured.

<Thickness of Adhesive Layer, Zinc Layer, and Tin Layer>

The thickness of the adhesive layer, the zinc layer, and the tin layer in the first film (the core wire contact planned part) was measured from a cross section in a field of 15 μm square, observing samples cross-sectioned with the focused ion beam system: FIB (model number: SMI3050TB) manufactured by Seiko Instruments Inc. with a scanning ion microscope. Two views were observed and the average value was taken.

<Presence of NiSn₄, Nickel Contents in Adhesive Layer and Copper-Tin Alloy Region>

Presence of NiSn₄ compound and its identification, and nickel content rate in the adhesive layer and the copper-tin alloy region of the mixed layer were measured by: using the focused ion beam system: FIB (model number: SMI3050TB) manufactured by Seiko Instruments Inc. to form samples of a cross section thinned to be 100 μm or less; using the scanning transmission type electron microscope: STEM (model number: Titan G2 ChemiSTEM) manufactured by FEI Company; observing the cross section at acceleration voltage 200 kV; and using an energy-dispersion X-ray spectrometer: EDS attached to the STEM.

<Adhesion Amount of Zinc and Added Elements>

The zinc adhesion amount and the adhesion amount of the added metal elements in the zinc layer were calculated by: cutting out the portion where the concerned layer is formed at a prescribed area from the sample; melting the zinc layer together with the tin layer by Stripper L80 made by LEYBOLD Co., Ltd.; and analyzing the concentration of zinc and the added elements contained in the solution by a high-frequency inductive coupling plasma emission analysis device. In Table 1, the adhesion amount per unit area (mg/cm2) were shown next to the added metal elements.

The results are shown in Table 1. In Table 1, blank columns in the heat treatment condition show that the heat treatment was not carried out.

TABLE 1

| First Film | | | | | | | | |
|---|---|---|---|---|---|---|---|---|
| | | | | | in Zinc | | | |
| | | | | Tin Layer | Layer Zinc | in Zinc | Second Film | |
| | Adhesion Layer | | in CuSn | Presence and | Adhesion | Layer Added | Exposed Rate | Heat |
| | Presence and | Presence | Ni Content | Thickness | Amount | element | (%) | Treatment |
| R1/R2 | Thickness (μm) | of NiSn₄ | (at %) | (μm) | (mg/cm²) | (mg/cm2) | of CuSn | Condition |

Example

| | | | | | | | | | |
|---|---|---|---|---|---|---|---|---|---|
| 1 | 0.05 | no | no | 0 | no | 0.05 | no | 3 | |
| 2 | 2.5 | no | no | 0 | no | 2.50 | no | 75 | |
| 3 | 0.1 | no | no | 0 | no | 0.02 | no | 5 | |
| 4 | 1.2 | no | no | 0 | no | 0.01 | no | 70 | 130° C.-0.5 h |
| 5 | 1.0 | Ni 0.01 | no | 0 | no | 0.05 | no | 60 | 150° C.-0.5 h |
| 6 | 0.08 | Ni₃Sn₄ 0.02 | no | 0.8 | no | 0.03 | no | 15 | 30° C.-24 h |
| 7 | 0.09 | Ni 0.15 | presence | 60 | no | 0.04 | no | 24 | 30° C.-24 h |
| 8 | 1.9 | Ni 1.0 | presence | 1 | no | 0.03 | no | 45 | 30° C.-24 h |
| 9 | 2.2 | Ni 0.6 | presence | 50 | no | 0.05 | no | 9 | 30° C.-24 h |
| 10 | 2.4 | Ni 1.0 | presence | 25 | 1.5 | 0.07 | no | 50 | 30° C.-24 h |
| 11 | 1.5 | Ni 0.2 | presence | 13 | 2.0 | 0.59 | Ni 0.1 | 61 | 30° C.-24 h |
| 12 | 1.1 | Ni—P 0.05 | presence | 9 | 0.3 | 0.30 | Fe 0.05 | 31 | 30° C.-24 h |
| 13 | 0.2 | Ni 0.9 | presence | 31 | 5.0 | 1.60 | Mn 0.2 | 8 | 30° C.-24 h |
| 14 | 0.07 | Ni 0.4 | presence | 6 | 0.1 | 2.00 | Mo 0.3 | 41 | 30° C.-24 h |
| 15 | 1.2 | Ni 0.07 | presence | 5 | 0.5 | 1.80 | Co 0.12 | 21 | 30° C.-24 h |
| 16 | 1.4 | Ni 0.05 | presence | 19 | 8.0 | 1.10 | Cd 0.13 | 19 | 30° C.-24 h |
| 17 | 1.0 | Ni 0.3 | presence | 41 | 1.2 | 0.20 | Pb 0.01 | 51 | 30° C.-24 h |

Comparative Example

| | | | | | | | | | |
|---|---|---|---|---|---|---|---|---|---|
| 18 | 0 | no | no | 0 | no | 0 | no | 0 | 30° C.-24 h |
| 19 | 3.0 | no | no | 0 | no | 0 | no | 100 | 30° C.-24 h |

Moreover, the contact planned part (the second film) of the samples of the obtained Examples 1 to 17 and Comparative Examples 18 and 19 were evaluated of the adhesiveness by the cross-cut test and the bending workability by the close-contact bend test. A shelf test in the corrosion environment and a friction test on the contact planned part were carried out in a state in which the terminal was formed and crimped the aluminum wire material.

<Adhesiveness>

The core wire contact planned part on which the first film to improve the corrosion resistance was evaluated by the cross-cut method of JIS K 5600-5-6. A cut interval was 1 mm. Ones in which an edge of cutting was smooth and no grid was peeled were defined “A”; ones in which there was a small peeling (5% or less of all) at a cross section of cutting were defined “B”; and in ones in which the film was peeled along the edge of cutting and/or the crossing part, the peeled part excessed 5% of all but not more than 35% were defined “C”, and the peeled part exceeded 35% were defined “D”. Since the first film was not formed in Comparative Examples 18 and 19, the test was carried out without specifying portions.

<Bending Test>

The bending workability of the core wire planned part on which the first film improving the corrosion resistance was evaluated by the bending test conforming the test method (item 4) of JCBA (Japan Copper and Brass Association Technology Standard) T307. That is, sample pieces having a width 10 mm×a length 30 mm were collected from the characteristic evaluation strip material so that the axis of bending was orthogonal to the rolling direction, and the test pieces were subjected to a W-bending test with a load 9.8×10³ N using a W-type jig having a bending angle of 90 degrees and a bending radius of 0.5 mm. Since the first film was not formed in Comparative Examples 18 and 19, the test was carried out without specifying portions.

Thereafter, the bended part was observed by the stereomicroscope and the bending workability was evaluated. Ones in which clear cracks were not recognized at the bended part after the bending test were defined “A”; ones in which minute cracks were partially generated on the plating surface but the exposure of the base material was not recognized were defined “B”; although the base material was not exposed but larger cracks than the level defined “B” were generated were defined “C”; and level in which the base material 2 was exposed by the generated cracks were defined “D”.

<Shelf Test in Corrosion Environment>

The samples were formed into the 090 type (commonly used name in automotive industry by the standard of terminals) female terminal to crimp pure aluminum wire material; the respective terminals were immersed in 5% sodium chloride aqueous solution (salt water) of 23° C. for 24 hours, then left in 85° C., 85% RH high temperature and high humidity environment for 24 hours; thereafter, contact resistance between the aluminum wire material and the terminal on the core wire contact planned part (the first film) was measured by four-terminal method. Electric current value was 10 mA. Since the first film was not formed in Comparative Examples 18 and 19, the test was carried out without specifying portions.

<Friction Test at Contact Planned Part>

For a contact planned part in which the second film reducing the friction coefficient was formed, a semi-spherical female test piece having an inner diameter of 1.5 mm and a plate-shape male test piece were formed for the samples to simulate a male terminal and a female terminal of a mating connector; and using a friction measuring machine (horizontal load tester type M-2152ENR) made by Aikoh Engineering Co., Ltd., the female test piece and the male test piece were slid to each other in a state in which a prescribed load was applied, so that frictional force between both test pieces was measured and the dynamic friction coefficient was obtained. Since the first film was not formed in Comparative Examples 18 and 19, the test was carried out without specifying portions.

These results are shown in Table 2.

TABLE 2

| | | | Corrosion | Contact Planned |
|---|---|---|---|---|
| | | Bending | Environment Test | Portion Friction |
| No. | Adhesiveness | Workability | (mΩ) | Coefficient |
| Example 1 | C | C | 8.8 | 0.50 |
| Example 2 | C | C | 9.5 | 0.45 |
| Example 3 | C | C | 6.5 | 0.31 |
| Example 4 | C | C | 7.9 | 0.29 |
| Example 5 | B | C | 8.1 | 0.33 |
| Example 6 | B | C | 6.6 | 0.25 |
| Example 7 | A | B | 7.1 | 0.26 |
| Example 8 | A | B | 8.0 | 0.30 |
| Example 9 | A | A | 9.0 | 0.29 |
| Example 10 | A | A | 5 | 0.28 |
| Example 11 | A | A | 2.1 | 0.31 |
| Example 12 | A | A | 3.0 | 0.32 |
| Example 13 | A | A | 1.9 | 0.30 |
| Example 14 | A | A | 1.2 | 0.27 |
| Example 15 | A | A | 2.5 | 0.30 |
| Example 16 | A | A | 0.9 | 0.31 |
| Example 17 | A | A | 1.3 | 0.29 |
| Comparative | D | D | 11.5 | 0.60 |
| Example 18 | | | | |
| Comparative | C | D | 120 | 0.41 |
| Example 19 | | | | |

From the results in Table 2, it is found that Examples 1 to 17 in which the ratio (R1/R2) between the copper-tin alloy region and the tin region in the mixed layer is 0.05 or more and 2.5 or less are better in the adhesiveness and the bending workability than Comparative Examples 18 and 19. Among them, Examples 5 to 17 having the adhesive layer were excellent in the adhesiveness; moreover, Examples 7 to 17 in which NiSn4 compound was recognized were particularly good in the adhesiveness. In Examples 9 to 17, the adhesiveness is good, and the cracks and peelings are not found in the bending work; the results were excellent in both adhesiveness and the bending workability.

Examples 1 to 17 are superior to Comparative Examples 18 and 19 in corrosion resistance. In particular, in Examples 10 to 17 having the tin layer on the zinc layer in the first film, having low contact resistance in the corrosion environment test; it is found that an effect of protecting the aluminum wire material from the galvanic corrosion occurring between the aluminum wire material and the terminal is especially high.

As for the contact planned part (the second film), the friction coefficient was relatively high as 0.4 or more in Examples 1 and 2 and Comparative Examples 18 and 19 in which the exposure rate of the copper-tin alloy region is too small or too large. The friction coefficient was low in Examples 3 to 17: it was found that the exposure rate of the copper-tin alloy region was appropriate in 5% or more and 70% or less.

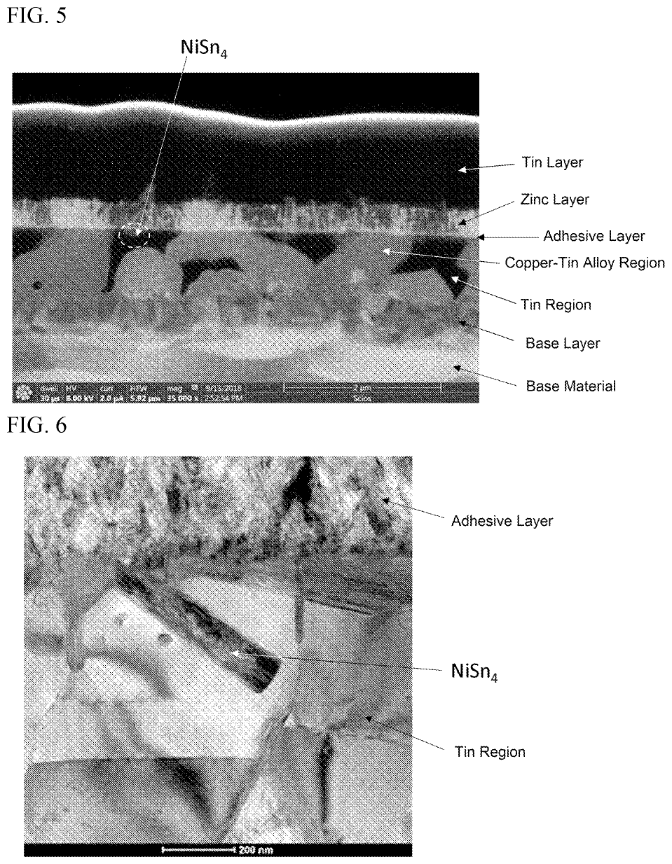

FIG. 5 is a cross sectional SIM image of a portion in which the first film was formed in Example 11: on the base material, the base layer, the mixed layer in which the copper-tin alloy region and the tin region are mixed, the adhesive layer, the zinc layer, and the tin layer are formed in order. FIG. 6 is an enlarged image of the portion surrounded by a circle in FIG. 5; it is found that columnar NiSn₄ extending from the boundary to the adhesive layer to the tin region.

In contrast, in Comparative Example 18, since the mixed layer having the copper-tin alloy region was not present and the zinc layer was formed on the tin layer, the results of the adhesiveness and the bending workability were deteriorated. Moreover, since the copper-tin alloy region was not exposed at the surface, the friction coefficient of the contact planned part was also high. In Comparative Example 19, the bending workability was remarkably bad because the tin layer present in the mixed layer was small; and also, very severe corrosion occurred in the aluminum wire material in the corrosion test. Furthermore, since the surface was almost covered with the copper-tin alloy region, the friction coefficient was also high comparing with Examples 3 to 17.

### INDUSTRIAL APPLICABILITY

The adhesiveness of the film to the base material is good, and the occurrence of dissimilar metal contact corrosion in contact with aluminum can be suppressed.

### REFERENCE SIGNS LIST

1 Anti-corrosion terminal
2 Base material
3 Film
31 First film
32 Second film
4 Base layer
5 Mixed layer
51 Copper-tin alloy region
52 Tin region
6 Adhesive layer
61 Intermetallic compound (NiSn₄)
7 Zinc layer
8 Tin layer
10 Terminal
11 Connection part
11a Spring piece
12 Electric wire
12a Core wire (Aluminum wire material)
12b Covering part
13 Core wire crimping part
14 Covering crimping part
25 Contact planned part
26 Core-wire contact planned part

1. An anti-corrosion terminal material provided with a base metal at least a surface is made of copper or copper alloy and a first film provided at at least a part of the base material, wherein
the first film has a mixed layer in which a copper-tin alloy region made of copper tin alloy and a tin region made of tin or tin alloy other than copper tin alloy, and a zinc layer made of zinc or zinc alloy provided on the mixed layer;
the zinc layer is in contact with both the copper-tin alloy region and the tin region of the mixed layer, a ratio R1/R2 is 0.05 or more and 2.5 or less where a length in contact with the copper-tin alloy region in a cross section along a thickness direction is R1 (μm) and a length in contact with the tin layer is R2 (μm).

2. The anti-corrosion terminal material according to claim 1 further comprising an adhesive layer made of nickel or nickel alloy between the mixed layer and the zinc layer in the first film.

3. The anti-corrosion terminal material according to claim 2 further comprising intermetallic compound made of NiSn₄ entering into the tin region from the adhesive layer.

4. The anti-corrosion terminal material according to claim 1, wherein the copper-tin alloy region contains not less than 1 at % and not more than 50 at % of nickel.

5. The anti-corrosion terminal material according to claim 1, wherein an adhesion amount of zinc per unit area of the zinc layer is not less than 0.07 mg/cm² and not more than 2.0 mg/cm².

6. The anti-corrosion terminal material according to claim 1, wherein the first film further has a tin layer made of tin or tin alloy provided on the zinc layer.

7. The anti-corrosion terminal material according to claim 1, wherein the zinc layer contains one or more of nickel, iron, manganese, molybdenum, cobalt, cadmium, and lead as an added element, and an adhesion amount of the added element per unit area is not less than mg/cm² 0.01 and not more than 0.3 mg/cm².

8. The anti-corrosion terminal material according to claim 1, wherein
a second film provided on a part of the base material in which the first film is not formed is provided,
the second film has a mixed layer provided on the base material, the copper-tin alloy region and the tin region are exposed on the surface of the mixed layer, and an exposed area rate of the copper-tin alloy region is not less than 5% and not more than 70%.

9. The anti-corrosion terminal material according to claim 1, comprising a strip-shaped carrier part and a plurality of terminal members connected to the carrier part at an interval in a longitudinal direction of the carrier part.

10. A terminal formed by forming the terminal member according to claim 9.

11. An electrical wire end section structure wherein the terminal according to claim 10 is crimped on an end of an electric wire formed of an aluminum wire material made of aluminum or aluminum alloy.

12. A terminal made by forming the anti-corrosion terminal material according to claim 1.

13. An electrical wire end section structure wherein the terminal according to claim 12 is crimped to an end of an electric wire formed of an aluminum wire made of aluminum or aluminum alloy.

14. The anti-corrosion terminal material according to claim 2, wherein the copper-tin alloy region contains not less than 1 at % and not more than 50 at % of nickel.

15. The anti-corrosion terminal material according to claim 3, wherein the copper-tin alloy region contains not less than 1 at % and not more than 50 at % of nickel.

16. The anti-corrosion terminal material according to claim 2, wherein an adhesion amount of zinc per unit area of the zinc layer is not less than 0.07 mg/cm² and not more than 2.0 mg/cm².

17. The anti-corrosion terminal material according to claim 3, wherein an adhesion amount of zinc per unit area of the zinc layer is not less than 0.07 mg/cm² and not more than 2.0 mg/cm².

18. The anti-corrosion terminal material according to claim 4, wherein an adhesion amount of zinc per unit area of the zinc layer is not less than 0.07 mg/cm² and not more than 2.0 mg/cm².

19. The anti-corrosion terminal material according to claim 2, wherein the first film further has a tin layer made of tin or tin alloy provided on the zinc layer.

20. The anti-corrosion terminal material according to claim 3, wherein the first film further has a tin layer made of tin or tin alloy provided on the zinc layer.
